(19) United States
(12) Patent Application Publication
(10) Pub. No.: US 2026/0318480 A1
(43) Pub. Date: Oct. 15, 2026

(54) LIQUEFIED GAS STORAGE FACILITY

(71) Applicant: GAZTRANSPORT ET TECHNIGAZ, SAINT-REMY-LES-CHEVREUSE (FR)

(72) Inventors: Benjamin FAUBRY, SAINT-REMY-LES-CHEVREUSE (FR); Sébastien DELANOE, SAINT-REMY-LES-CHEVREUSE (FR); Guillaume SALMON LEGAGNEUR, SAINT-REMY-LES-CHEVREUSE (FR)

(21) Appl. No.: 19/484,183

(22) PCT Filed: May 14, 2024
(86) PCT No.: PCT/EP2024/063156

§ 371 Date: Nov. 13, 2025

(30) Foreign Application Priority Data
May 16, 2023 (FR) FR2304852

(51) Int. Cl. F17C 3/02

(52) U.S. Cl. CPC F17C 3/025; F17C 2203/03; F17C 2203/0626; F17C 2205/0352; F17C 2223/0153; F17C 2223/033; F17C 2260/033; F17C 2270/0105

(57) ABSTRACT

A liquefied gas storage facility has a through-structure positioned in a passage extending through a load-bearing roof wall and a tank wall. The through-structure has a main envelope sealingly delimiting an internal space at an absolute pressure of less than 10 Pa. The main envelope has a central portion, an inner portion, an outer portion, and an outer peripheral fastening element connecting the outer portion to the load-bearing roof wall. A closure wall extends around and at a distance from the central portion. The closure wall sealingly connects the outer peripheral fastening element to a sealed membrane. The sealed membrane is sealingly fastened to an inner peripheral fastening element. The through-structure also has a sealed pipe.

### TECHNICAL FIELD

The invention relates to the field of liquefied-gas storage facilities. In particular, the invention relates to the field of liquefied-gas storage facilities comprising a sealed and thermally insulating tank for storing and/or transporting a liquefied gas, such as liquid hydrogen, which is at approximately −253 °C at atmospheric pressure.

### TECHNOLOGICAL BACKGROUND

Facilities having a sealed and thermally insulating tank for storing liquefied gas, such as liquefied natural gas (LNG), are known in the prior art. Such a tank has a multi-layer structure successively having, in a thickness direction from the outside of the tank, a secondary thermally insulating barrier, a secondary sealing membrane, a primary thermally insulating barrier and a primary sealing membrane delimiting an internal space of the tank, said internal space being intended to contain a liquefied gas.

Such a facility comprises a load-bearing roof wall. It is known practice in the prior art to form a through-passage in a roof wall in order for a pipework system, which may be referred to as the “liquid dome” and which opens into the internal space of the tank, to be inserted therein.

### SUMMARY OF THE INVENTION

The inventors have found that the very low temperature of liquid hydrogen and the presence of thermal bridges in such a passage could cause cold spots at the load-bearing wall that could result in liquefaction of the air and impairment of the load-bearing wall, which for example partially forms the hull of the ship.

Furthermore, the inventors have found that the presence of thermal bridges could also cause cold spots at the secondary membrane that result in the liquefaction of the gas present at the secondary thermally insulating barrier. Such liquefaction could cause damage in the secondary barrier and in the load-bearing wall.

Thus, it is important to avoid cold spots at the hull, in particular in order to avoid liquefaction of the air and impairment of the hull of the ship.

It is therefore also important to avoid cold spots at the secondary membrane in order to avoid condensation of the gas present at the secondary thermally insulating barrier.

One idea underlying the invention is that of solving one or more of the abovementioned problems.

One idea underlying the invention is that of proposing a liquefied-gas storage facility having a through-structure that opens into the internal space in order to allow a fluid, such as liquefied gas, for example liquefied hydrogen or LH2, to pass from the outside of the tank towards the inside of the tank, or vice versa.

One idea underlying the invention is that of proposing a liquefied-gas storage facility having a through-structure that opens into the internal space of the tank and is optimized in order to limit thermal bridges at the through-structure.

According to one embodiment, the invention provides a liquefied-gas storage facility having a load-bearing structure and a sealed and thermally insulating tank that is installed in the load-bearing structure, the load-bearing structure comprising a load-bearing roof wall, the sealed and thermally insulating tank having a tank wall that is fastened to the load-bearing roof wall, the tank wall successively having, in a thickness direction from the outside of the tank, a secondary thermally insulating barrier, a secondary sealing membrane, a primary thermally insulating barrier and a primary sealing membrane delimiting an internal space of the tank, said internal space being intended to contain a liquefied gas,
said liquefied-gas storage facility having a through-structure that is borne by the load-bearing roof wall and positioned in a passage formed through the load-bearing roof wall and the tank wall, the through-structure having:
a main shell delimiting an interior space in a sealed manner, said main shell comprising:
a central portion extending in the thickness direction between the load-bearing roof wall and the primary sealing membrane,
an internal portion in contact with the internal space,
an external portion projecting towards the outside of the tank from the load-bearing roof wall,
said interior space containing a gas phase at an absolute pressure of less than 10 Pa,
an external peripheral fastening element connecting the external portion of the main shell to the load-bearing roof wall all around said passage,
a secondary closure wall extending around the central portion of the main shell at a distance from the central portion, the secondary closure wall connecting the external peripheral fastening element to the secondary sealing membrane in a sealed manner, in order to close the secondary thermally insulating barrier all around said passage and to form an intermediate space between the secondary closure wall and the central portion of the main shell, the intermediate space being in communication with the primary thermally insulating barrier,
an internal peripheral fastening element that projects towards the outside of the internal portion, the primary sealing membrane being fastened to the internal peripheral fastening element in a sealed manner all around the main shell,
and a sealed pipeline that passes successively through the external portion, the interior space and the internal portion of the main shell and opens into the internal space, an internal portion of the sealed pipeline being fastened to the internal portion of the main shell.

By virtue of these features, it is possible to obtain a gas storage facility that allows a liquid such as liquid hydrogen and/or a gas such as hydrogen to pass between the outside and the inside of the tank while at the same time greatly reducing the thermal bridges in the passage. Such a facility makes it possible to protect the secondary sealing membrane and the load-bearing roof wall from cold spots.

Specifically, the presence of the intermediate space tends to increase the length of a thermal conduction path from the internal space of the tank to the load-bearing roof wall with respect to the known through-structures that are used in particular for tanks intended to contain LNG. Moreover, the use of a sealed shell limits the convective flows around the sealed pipeline. As a result, the load-bearing roof wall and the secondary sealing membrane may be protected.

According to various embodiments, such a liquefied-gas storage facility may have one or more of the following features.

According to one variant embodiment of the internal peripheral fastening element, the internal peripheral fastening element projects towards the outside of the central portion.

According to one embodiment, the gas phase contained in the interior space of the through-structure is at an absolute pressure of less than 1 Pa, preferably of less than 10⁻³ Pa.

According to one embodiment, the interior space of the main shell has a thermal insulator selected from among: glass wool, perlite or a material designated by the initials MLI (multi-layer insulation), in order to increase the thermal insulation of the interior space of the main shell.

According to one embodiment, the external peripheral fastening element has an external flange that is fastened to the load-bearing roof wall all around said passage.

According to one embodiment, the flange is made of metal and fastened to the load-bearing roof wall by welding.

According to one embodiment, the external peripheral fastening element has an external peripheral shell that connects the external portion of the main shell to the external flange.

According to one embodiment, the external peripheral shell extends from the external portion of the main shell, around the external portion of the main shell, and is arranged so as to close the intermediate space.

According to one embodiment, the external peripheral shell has a first wall projecting towards the outside from the external portion of the main shell, all around the main shell, and a second wall connecting the first wall to the external flange, all around the external flange.

According to one embodiment, the second wall of the external peripheral shell is located facing the secondary closure wall with respect to the external flange.

According to one embodiment, the external flange extends parallel to the load-bearing roof wall inside the passage and has a first portion that forms part of the main shell and a second portion that projects out of the main shell in order to connect the main shell to the load-bearing roof wall all around said passage,
the external portion of the main shell having:
a first wall projecting towards the outside of the tank from the first portion of the external flange,
a second wall located at a distance from the first wall towards the inside of the passage and arranged so as to close the intermediate space, the second wall having the form of a broken line having an outward portion that projects towards the outside of the tank from the first portion of the external flange, and a returning portion that extends from the outward portion towards the inside of the tank in the thickness direction.

According to one embodiment, the main shell has a shape exhibiting symmetry of revolution, and wherein the central portion comprises a side wall that has an internal end and an external end, the internal portion comprises a bottom wall that closes the internal end of the side wall and through which the sealed pipeline passes, and the external portion comprises a cover wall that closes the external end of the side wall and through which the sealed pipeline passes.

According to one embodiment, the main shell has a diameter of between 800 mm and 1500 mm, preferably a diameter of between 1000 mm and 1200 mm.

According to one embodiment, the view in cross section perpendicular to the thickness direction of the main shell has a circular or rectangular shape.

According to one embodiment, the distance between the internal end and the external end of the main shell is at least 80 cm, preferably 100 cm.

According to one embodiment, an external portion of the sealed pipeline is connected to an exterior surface of the external portion of the main shell in a sealed manner by a compensation bellows, the compensation bellows being intended to absorb variations in length resulting from thermal contraction.

Thus, the bellows makes it possible, in particular, to absorb not only the vertical thermal contraction but also the radial thermal contraction in the lower part.

According to one embodiment, the sealed pipeline has a peripheral double wall that encloses a peripheral space under vacuum, the peripheral space under vacuum is preferably at a pressure of less than 10 Pa, and more preferably at a pressure of less than 1 Pa.

Thus, the space under vacuum makes it possible to increase the thermal insulation of the sealed pipeline.

According to one embodiment, the peripheral double wall of the sealed pipeline extends from the interior space of the main shell to the outside of the external portion of the main shell.

According to one embodiment, the sealed pipeline has a peripheral double wall, the peripheral space of which is in communication with the interior space of the main shell. In this embodiment, the pressure in the peripheral space is identical to the pressure in the interior space of the main shell.

According to one embodiment, a thermal insulator is positioned against an exterior surface of the sealed pipeline.

According to one embodiment, the thermal insulator covers the exterior surface of the sealed pipeline that is located in the interior space of the main shell, preferably covers the entirety of said exterior surface.

According to one embodiment, the through-structure has an internal anchoring cylinder that projects from the internal portion of the main shell towards the internal space of the tank, the sealed pipeline being fastened to said internal anchoring cylinder in a sealed manner.

According to one embodiment, the through-structure has a plurality of sealed pipelines that pass successively through the external portion, the interior space and the internal portion of the main shell and open into the internal space of the tank.

According to one embodiment, the plurality of sealed pipelines that pass successively through the external portion has one or more of the features mentioned for the sealed pipeline.

The plurality of sealed pipelines may have pipelines having identical or different features.

According to one embodiment, the plurality of sealed pipelines has between 2 and 10 sealed pipelines, preferably between 3 and 7, for example 4, 5 or 6 pipelines.

According to one embodiment, a stiffener extends through the interior space of the main shell between the internal portion and the external portion, the stiffener being fastened to said internal portion and to said external portion of the main shell.

By virtue of these features, the deflection of the internal portion and external portion under the effect of the pressure is reduced.

According to one embodiment, the stiffener has a rigid core connecting the internal portion and the external portion. According to one embodiment, the core is made from a composite material with low thermal conductivity.

According to one embodiment, the interior space of the main shell is lined with thermal insulation, which is preferably selected from among glass wool, perlite and multi-layer insulators.

According to one embodiment, the gas phase of the primary thermally insulating barrier is at an absolute pressure of less than 1 Pa, advantageously of less than 10⁻¹ Pa, preferably of less than 10⁻² Pa and for example of the order of 10⁻³ Pa.

According to one embodiment, the internal portion of the main shell has a domed shape.

According to one embodiment and in a view from the internal space of the tank, the internal portion of the main shell has a convex shape, the apex of which is located in the internal space.

By virtue of these features, the deflection of the internal portion under the effect of the pressure is reduced.

According to one embodiment, the liquefied gas is liquid hydrogen (LH2).

According to one embodiment, the primary sealing membrane has a planar peripheral portion located around the passage and fastened to the internal flange all around said passage, preferably by welding.

According to one embodiment, the primary sealing membrane is welded against an internal face of the internal peripheral fastening element, preferably of the internal flange.

According to one embodiment, the primary sealing membrane is welded against an external face of the internal peripheral fastening element, preferably of the internal flange.

According to one embodiment, the through-structure is produced entirely or partially from Invar® or from stainless steel.

According to one embodiment, the primary sealing membrane is corrugated.

According to one embodiment, the primary sealing membrane and/or the secondary sealing membrane have/has a plurality of corrugated metal sheets, each corrugated metal sheet having edges that are each lap welded to an edge of an adjacent corrugated metal sheet.

Such a liquefied-gas storage facility may form part of an onshore storage facility, or be installed in a floating, inshore or offshore structure, in particular a ship for transporting liquid hydrogen, i.e. a hydrogen tanker, a floating storage and regasification unit (FSRU), a floating production storage and offloading (FPSO) unit, and the like. Such a tank can also be used as a fuel tank on any type of ship.

According to one embodiment, a ship for transporting a liquefied gas has a double hull and an abovementioned liquefied-gas storage facility arranged in the double hull.

According to one embodiment, the invention also provides a transfer system for a liquefied gas, the system having the abovementioned ship and insulated pipelines that are arranged so as to connect the liquefied-gas storage facility installed in the hull of the ship to a floating or onshore storage facility.

According to one embodiment, the transfer system also has a pump for causing liquefied gas to flow through the insulated pipelines from or to the floating or onshore storage facility to or from the liquefied-gas storage facility of the ship.

According to one embodiment, the invention also provides a method for loading or offloading such a ship, wherein a liquefied gas is conveyed through insulated pipelines from or to a floating or onshore storage facility to or from the liquefied-gas storage facility of the ship.

### BRIEF DESCRIPTION OF THE FIGURES

The invention will be better understood, and further aims, details, features and advantages thereof will become more clearly apparent, in the course of the following description of several particular embodiments of the invention, which are given solely by way of non-limiting illustration, with reference to the appended drawings.

FIG. 1 is a partial view in cross section along the thickness direction of a liquefied-gas storage facility according to a first embodiment.

FIG. 2 is a partial enlarged perspective view of a through-structure according to the first embodiment.

FIG. 3 is a partial view in cross section along the thickness direction of a liquefied-gas storage facility according to a second embodiment.

FIG. 4 is a cut-away schematic depiction of a tank of a ship, and of a terminal for loading/offloading this tank.

### DESCRIPTION OF THE EMBODIMENTS

By convention, the terms “external” and “internal” are used to define the relative position of one element with respect to another, with reference to the outside and to the inside of the liquefied-gas storage facility.

The liquefied gas intended to be stored in the tank may in particular be liquid hydrogen, which has the particular feature of being stored at approximately −253 °C at atmospheric pressure.

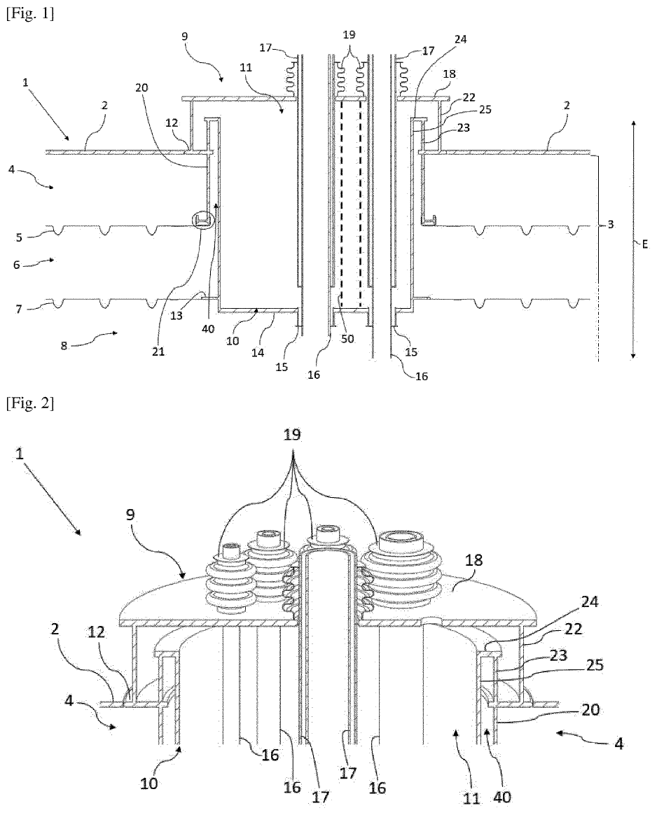

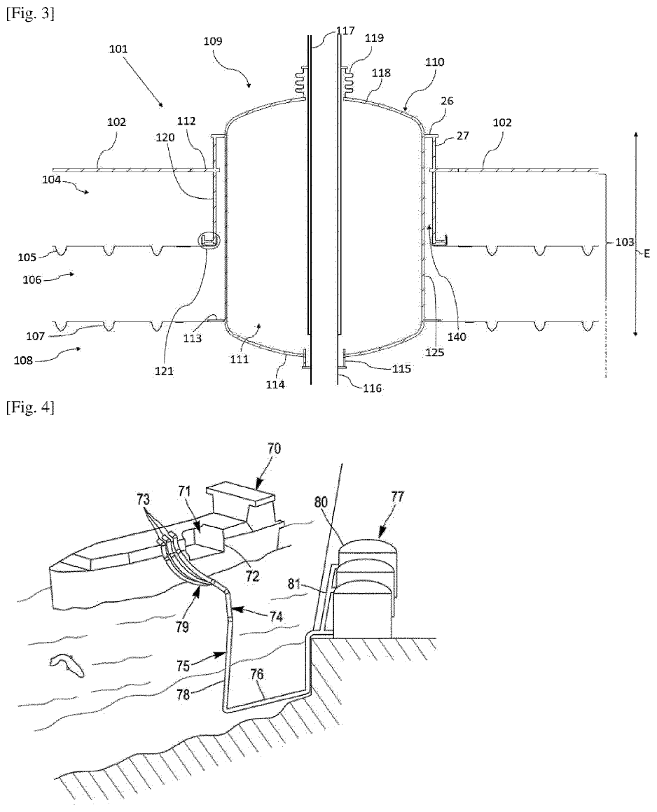

FIGS. 1 and 2 illustrate a first embodiment of the through-structure 9 of the liquefied-gas storage facility 1. FIG. 3 shows a second embodiment of the through-structure 109 of the liquefied-gas storage facility 100.

In FIG. 3, elements that are identical or similar to those illustrated in FIGS. 1 and 2 bear the same reference number incremented by 100.

In relation to FIGS. 1 to 3, the liquefied-gas storage facility according to various embodiments has a load-bearing structure and a sealed and thermally insulating tank that is installed in the load-bearing structure.

The load-bearing structure may in particular be formed of self-supporting metal sheets or, more generally, of any type of rigid partition having suitable mechanical properties. The load-bearing structure is, for example, formed by the double hull of a ship.

For example, in FIGS. 1 to 3, the liquefied-gas storage facility 1, 101 comprises a load-bearing structure having a load-bearing roof wall 2, 102 that forms part of the deck of a ship, for example, and a sealed and thermally insulating tank 3, 103.

The sealed and thermally insulating tank 3, 103 has a plurality of tank walls that form, for example, a tank with a polyhedral overall shape (not shown), such as an octagonal shape.

The tank wall has a multi-layer structure having, in the thickness direction E of the wall of the tank, from the outside to the inside, a secondary thermally insulating barrier 4, 104, a secondary sealing membrane 5, 105, a primary thermally insulating barrier 6, 106 and a primary sealing membrane 7, 107 that is intended to be in contact with the liquefied gas contained in the tank, the primary sealing membrane 7, 107 delimiting an internal space 8, 108 of the tank 3, said internal space being intended to contain a liquefied gas, such as liquefied hydrogen. This multi-layer structure may be produced in various ways.

The secondary sealing membrane 5, 105 has corrugations and, more particularly, a first series of corrugations extending parallel to a first direction and a second series of corrugations extending parallel to a second direction. The directions of the series of corrugations are mutually perpendicular. Each of the series of corrugations is parallel to two opposite edges of the corrugated metal sheet. In this case, the corrugations project towards the inside of the tank, i.e. towards the internal space 8, 108 of the tank 3, 103. The secondary sealing membrane 5, 105 has a plurality of planar regions between the corrugations.

The primary sealing membrane 7, 107 may have the same features as the secondary sealing membrane 5, 105.

The pitch of the corrugations of the secondary sealing membrane 5, 105 is equal to the pitch of the corrugations of the primary sealing membrane 7, 107 or to an integer multiple thereof. Furthermore, each of the corrugations of the secondary sealing membrane 5, 105 is arranged facing, in the thickness direction of the wall, a corrugation of the primary sealing membrane 7, 107. Thus, each planar region of the primary sealing membrane 7, 107 is located facing, in the thickness direction of the wall of the tank, a planar region of the secondary sealing membrane 5, 105. Consequently, the secondary sealing membrane 5, 105 and the primary sealing membrane 7, 107 are anchored, by welding, onto load-bearing elements at their planar region, for example by spot welds.

In addition, the primary thermally insulating barrier 6, 106 has a gas phase that is at a reduced pressure, i.e. is at an absolute pressure that is lower than the atmospheric pressure, in order to confer the required thermal insulation properties on the primary thermally insulating barrier 6, 106. The gas phase of the primary thermally insulating barrier 6, 106 is, advantageously, placed at an absolute pressure of less than 1 Pa, advantageously of less than 10⁻¹ Pa, preferably of less than 10⁻² Pa and for example of the order of 10⁻³ Pa. To this end, the primary thermally insulating barrier 6, 106 is advantageously connected to a vacuum pump.

A first embodiment of the through-structure 9 of the liquefied-gas storage facility 1 illustrated in FIGS. 1 and 2 will now be described.

The through-structure 9 is positioned in a passage formed through the load-bearing roof wall 2 and the tank wall, i.e. passing through the secondary thermally insulating barrier 4, the secondary sealing membrane 5, the primary thermally insulating barrier 6 and the primary sealing membrane 7. The through-structure 9 fills said passage.

The through-structure 9 has a main shell 10 that is positioned in the passage, the main shell 10 is formed by a plurality of walls and delimits an interior space 11 under vacuum in a sealed manner. The interior space 11 of the main shell 10 contains a gas phase at an absolute pressure of less than 10 Pa, for example of less than 1 Pa, of less than 10⁻² Pa or of less than 10⁻³ Pa.

This interior space may furthermore have thermal insulation such as glass wool, perlite or a material designated by the initials MLI (multi-layer insulation), for example the interior space is filled with perlite.

The through-structure 9 is fastened within the passage via an external flange 12 that projects from an external portion, i.e. from a portion that projects towards the outside of the tank 3 from the load-bearing roof wall 2 of the through-structure 9. The external flange 12 is welded to the load-bearing roof wall 2 all around the passage.

A secondary closure wall 20 extends around the central portion of the main shell 10 between the load-bearing roof wall 2 and the primary sealing membrane 7 of the main shell 10 and at a distance from the main shell 10. The secondary closure wall 20 connects the external flange 12 to the secondary sealing membrane 5 via a fastening region 21, which is for example U-shaped, in order to close the secondary thermally insulating barrier 4 all around said passage in a sealed manner and to form an intermediate space 40 between the secondary closure wall 20 and the central portion of the main shell 10. The intermediate space 40 is in communication with the primary thermally insulating barrier 6. Thus, the gas phase of the intermediate space is identical to the gas phase of the primary thermally insulating barrier 6, i.e. at an absolute pressure of less than 1 Pa, for example of less than 10⁻² Pa.

The U-shaped fastening region 21 has, for example, a metal piece to which the secondary sealing membrane 5 is welded, on a first surface, and a portion of the secondary closure wall 20 is welded, on a second surface opposite the first surface.

The sealing at the passage between the internal space 8 of the tank 3 and the primary thermally insulating barrier 6 is provided by an internal flange 13 that projects from a lower portion of the main shell 10 to which the primary sealing membrane 7 is welded, all around said internal flange 13. FIG. 1 illustrates, by way of example, welding of the sealing membrane 7 against an internal face of the internal flange 13.

The primary sealing membrane 7 has a planar fastening region, i.e. a region of the primary sealing membrane 7 that does not have any corrugations and that is welded to the internal flange 13.

Sealed pipelines 16, which are for example four in number in FIG. 2, pass all the way through the main shell 10 in the thickness direction E, by passing through the interior space 11.

The main shell 10 has a bottom wall 14 that is in contact with the internal space 8. The bottom wall 14 projects into the internal space 8 and closes the main shell 10 at an internal end of the main shell 10.

The bottom wall 14 has two internal anchoring cylinders 15 that are located at a distance from one another and project towards the internal space 8 of the tank. The two sealed pipelines 16 are respectively fastened to an internal anchoring cylinder 15 in a sealed manner all the way around said internal anchoring cylinder 15.

The two internal anchoring cylinders 15 have different dimensions to one another. According to one variant, the two internal anchoring cylinders 15 have identical dimensions. The dimensions of an anchoring cylinder 15 are chosen so as to be suitable for receiving and fastening a pipeline 16 in a sealed manner.

For reasons of clarity in FIG. 1, only two sealed pipelines 16 have been illustrated, and the other pipelines, such as those shown in FIG. 2, have been omitted from FIG. 1.

The sealed pipelines 16 each have a peripheral double wall 17 that extends from the interior space 11 of the main shell 10 to the outside of the liquefied-gas storage facility 9. The peripheral double wall 17 forms a peripheral space that is in communication with the interior space 11 of the main shell. Thus, the peripheral space has a pressure that is identical to the pressure of the interior space 11 of the main shell 10. The peripheral double wall 17 makes it possible to increase the thermal insulation of the sealed pipelines 16.

According to a variant that is not shown, the peripheral double wall forms an internal space that is not in communication with the interior space 11. In this case, the pressure of the gas phase in the peripheral space may be identical or different to the pressure of the gas phase in the interior space 11 of the main shell 10.

The main shell 10 comprises a roof wall 18 that is located at a distance from the flange 12 towards the outside of the tank and a wall 22 that is perpendicular to the roof wall and connects the roof wall 18 to the flange 12, all around the flange 12.

The sealed pipelines 16 pass through the roof wall 18. The sealed pipelines 16 are each connected to the roof wall 18 by a compensation bellows 19 in order to absorb variations in length resulting from thermal contraction, for example during the loading and offloading of liquefied gas into and from the internal space 8 of the tank 3, which results in significant temperature variations.

The main shell 10 also has a second wall, which has the form of a broken line having an outward portion 23, a plateau 24 and a returning portion 25. This second wall is arranged so as to close the intermediate space at an external portion of the main shell 10.

The outward portion 23 projects towards the outside of the tank from a portion of the external flange 12 that is located inside the passage and forms a portion of the main shell 10. The outward portion 23 is located facing the secondary closure wall 20 with respect to the external flange 12.

The plateau 24 extends from the outward portion 23 towards the inside of the passage. The plateau 24 is perpendicular to the central portion 23, parallel to the roof wall 18 and located at a distance from the roof wall 18.

The returning portion 25 extends in a perpendicular manner from the plateau 24, parallel to the outward portion 23 and to the closure wall 20, towards the inside of the tank 3 in the thickness direction and is continued in the form of a side wall of the main shell 10 until it connects to the bottom wall 14.

According to a second embodiment illustrated by FIG. 3, the liquefied-gas storage facility 101 differs from the first embodiment in that the main shell 110 has a cylindrical shape and in that the roof wall 118 and the bottom wall 114 have a convex shape, as seen from the outside of the main shell 110. By virtue of these features, the deflection of the internal portion comprising the bottom wall 114 and of the external portion comprising the roof wall of the main shell 110 is reduced.

Furthermore, the roof wall 118 is connected to the external flange 112 via an external peripheral shell that extends from the roof wall 118 of the main shell 110, around the roof wall 118, and is arranged so as to close the intermediate space 140.

The external peripheral shell has a first wall 26 projecting towards the outside from the roof wall 118, all around the main shell 110, and a second wall 27 connecting the first wall 26 to the external flange 112, all around the external flange 112.

With reference to FIG. 4, a cut-away view of a ship 70 shows a liquefied-gas storage facility 71 with a prismatic overall shape mounted in the double hull 72 of the ship. The wall of the tank 71 has a primary sealing membrane intended to be in contact with the liquefied gas, preferably liquid hydrogen, contained in the internal space of the tank, a secondary sealing membrane arranged between the primary sealing membrane and the double hull 72 of the ship, and two thermally insulating barriers arranged between the primary sealing membrane and the secondary sealing membrane, and between the secondary sealing membrane and the double hull 72, respectively.

In a manner known per se, loading/offloading pipelines 73 arranged on the upper deck of the ship can be connected, by means of suitable connectors, to a maritime or harbour terminal in order to transfer a cargo of liquefied gas from or to the liquefied-gas storage facility 71.

FIG. 4 also shows an example of a maritime terminal having a loading and offloading station 75, an underwater pipe 76 and an onshore facility 77. The loading and offloading station 75 is a fixed offshore facility having a mobile arm 74 and a tower 78 that supports the mobile arm 74. The mobile arm 74 bears a bundle of insulated flexible hoses 79 that can be connected to the loading/offloading pipelines 73. The orientable mobile arm 74 adapts to all sizes of ship. A connecting pipe (not shown) extends inside the tower 78. The loading and offloading station 75 allows the ship 70 to be loaded and offloaded from or to the onshore facility 77. This facility has liquefied-gas storage tanks 80 and connecting pipes 81 connected via the underwater pipe 76 to the loading or offloading station 75. The underwater pipe 76 makes it possible to transfer the liquefied gas between the loading or offloading station 75 and the onshore facility 77 over a long distance, for example 5 km, allowing the ship 70 to be kept standing off shore by a long distance during the loading and offloading operations.

In order to generate the pressure needed for transferring the liquefied gas, either use may be made of pumps on board the ship 70 and/or of pumps with which the onshore facility 77 is equipped and/or of pumps with which the loading and offloading station 75 is equipped or an increase in pressure in the internal space of the tank under the effect of the evaporation of the liquefied gas stored in the tank may be authorized.

Although the invention has been described in connection with several particular embodiments, it is quite obvious that it is in no way limited thereto and that it comprises all of the technical equivalents of the means described and also their combinations, if these fall within the scope of the invention.

The use of the verbs “to have”, “to comprise” or “to include” and of their conjugated forms does not exclude the presence of elements or of steps other than those mentioned in a claim.

In the claims, any reference sign between parentheses should not be understood as a limitation of the claim.

It will be more generally apparent to those skilled in the art that various modifications may be made to the embodiments described above, in light of the teaching that has just been disclosed to them. In the claims that follow, the terms that are used should not be interpreted as limiting the claims to the embodiments set out in the present description, but should be interpreted so as to include therein all of the equivalents that the claims are intended to cover by virtue of their wording and as may be foreseen by those skilled in the art on the basis of their general knowledge.

1. A liquefied gas storage facility having a load-bearing structure and a sealed and thermally insulating tank that is installed in the load-bearing structure, the load-bearing structure comprising a load-bearing roof wall, the sealed and thermally insulating tank having a tank wall that is fastened to the load-bearing roof wall, the tank wall successively having, in a thickness direction from the outside of the tank, a secondary thermally insulating barrier, a secondary sealing membrane a primary thermally insulating barrier and a primary sealing membrane, delimiting an internal space of the tank, said internal space being intended to contain a liquefied gas,
said liquefied-gas storage facility having a through-structure that is borne by the load-bearing roof wall and positioned in a passage formed through the load-bearing roof wall and the tank wall, the through-structure having:
a main shell delimiting an interior space in a sealed manner, said main shell comprising:
a central portion extending in the thickness direction between the load-bearing roof wall and the primary sealing membrane,
an internal portion in contact with the internal space, and
an external portion projecting towards the outside of the tank from the load-bearing roof wall, said interior space containing a gas phase at an absolute pressure of less than 10 Pa,
an external peripheral fastening element connecting the external portion of the main shell to the load-bearing roof wall all around said passage,
a secondary closure wall extending around the central portion of the main shell at a distance from the central portion, the secondary closure wall connecting the external peripheral fastening element to the secondary sealing membrane in a sealed manner, in order to close the secondary thermally insulating barrier all around said passage and to form an intermediate space between the secondary closure wall and the central portion of the main shell, the intermediate space being in communication with the primary thermally insulating barrier,
an internal peripheral fastening element that projects towards the outside of the internal portion or of the central portion, the primary sealing membrane being fastened to the internal peripheral fastening element in a sealed manner all around the main shell, and
a sealed pipeline that passes successively through the external portion, the interior space and the internal portion of the main shell and opens into the internal space, an internal portion of the sealed pipeline being fastened to the internal portion of the main shell.

2. The liquefied gas storage facility according to claim 1, wherein the external peripheral fastening element has an external flange that is fastened to the load-bearing roof wall all around said passage.

3. The liquefied gas storage facility according to claim 2, wherein the external peripheral fastening element has an external peripheral shell that connects the external portion of the main shell to the external flange

4. The liquefied gas storage facility according to claim 3, wherein the external peripheral shell extends from the external portion of the main shell, around the external portion of the main shell, and is arranged so as to close the intermediate space.

5. The liquefied gas storage facility according to claim 2, wherein the external flange extends parallel to the load-bearing roof wall inside the passage and has a first portion that forms part of the main shell and a second portion that projects out of the main shell in order to connect the main shell to the load-bearing roof wall all around said passage, the external portion of the main shell having:
a first wall projecting towards the outside of the tank from the first portion of the external flange,
a second wall located at a distance from the first wall towards the inside of the passage and arranged so as to close the intermediate space, the second wall having the form of a broken line having an outward portion that projects towards the outside of the tank from the first portion of the external flange, and a returning portion that extends from the outward portion towards the inside of the tank in the thickness direction.

6. The liquefied gas storage facility according to claim 1, wherein the main shell has a shape exhibiting symmetry of revolution, and wherein the central portion comprises a side wall that has an internal end and an external end, the internal portion comprises a bottom wall that closes the internal end of the side wall and through which the sealed pipeline passes, and the external portion comprises a cover wall (118) that closes the external end of the side wall and through which the sealed pipeline passes.

7. The liquefied gas storage facility according to claim 1, wherein an external portion of the sealed pipeline is connected to an exterior surface of the external portion of the main shell in a sealed manner by a compensation bellows, the compensation bellows being intended to absorb variations in length resulting from thermal contraction.

8. The liquefied gas storage facility according to claim 1, wherein the through-structure has an internal anchoring cylinder that projects from the internal portion of the main shell towards the internal space of the tank, the sealed pipeline being fastened to said internal anchoring cylinder in a sealed manner.

9. The liquefied gas storage facility according to claim 1, wherein the sealed pipeline has a peripheral double wall that encloses a peripheral space under vacuum, the peripheral space under vacuum being preferably at a pressure of less than 10 Pa, and more preferably at a pressure of less than 1 Pa.

10. The liquefied gas storage facility according to claim 1, wherein the through-structure has a plurality of sealed pipelines that pass successively through the external portion, the interior space and the internal portion of the main shell and open into the internal space of the tank.

11. The liquefied gas storage facility according to claim 1, wherein a stiffener extends through the interior space of the main shell between the internal portion and the external portion, the stiffener being fastened to said internal portion and to said external portion of the main shell.

12. The liquefied gas storage facility according to claim 1, wherein the interior space of the main shell is lined with thermal insulation, which is selected from among glass wool, perlite and multi-layer insulators.

13. The liquefied gas storage facility according to claim 1, wherein the gas phase of the primary thermally insulating barrier is at an absolute pressure of less than 1 Pa.

14. A ship for transporting a liquefied gas, the ship having a double hull and a liquefied-gas storage facility according to claim 1 arranged in the double hull.

15. A transfer system for a liquefied gas, the system having a ship according to claim 14 and insulated pipelines that are arranged so as to connect the liquefied-gas storage facility installed in the hull of the ship to a floating or onshore storage facility.

16. A method for loading or offloading a ship according to claim 14, wherein a liquefied gas is conveyed through insulated pipelines from or to a floating or onshore storage facility to or from the liquefied-gas storage facility of the ship.
